(19) United States
(12) Patent Application Publication
(10) Pub. No.: US 2017/0308913 A1
(43) Pub. Date: Oct. 26, 2017

(54) DRILL-DOWN APPROACH TO PROVIDING DATA ABOUT ENTITIES IN A SOCIAL GRAPH

(71) Applicant: LinkedIn Corporation, Mountain View, CA (US)

(72) Inventors: John Chao, Foster City, CA (US); Derek Koh, Sunnyvale, CA (US); Paul Ko, San Francisco, CA (US); Lindsey Bly, San Francisco, CA (US); Wenjing Zhang, Menlo Park, CA (US); Clay Blanchard, Danville, CA (US); Carson Moore, San Francisco, CA (US); Michael Derezin, Alamo, CA (US)

(21) Appl. No.: 15/135,371

(22) Filed: Apr. 21, 2016

(51) Int. Cl. G06Q 30/02; G06F 17/30; G06Q 50/00

(52) U.S. Cl. CPC G06Q 30/0202; G06Q 50/01; G06F 17/3053; G06F 17/30867

(57) ABSTRACT

Techniques are provided for displaying information about entities in a social network. An analysis of profiles of multiple representatives is performed. Each representative is registered with a social network provider and represents an organization from multiple organizations. Based on the analysis, the organizations are ranked. Data about a subset of the organizations is presented, based on the ranking, through a user interface. A user selects an indicator that is associated with a particular organization of the multiple organizations. In response to the input, a subset of the representatives is identified. One or more scores that were generated for a particular representative in the subset are determined. Data about the subset of the representatives is caused to be presented through the user interface. The data identifies the one or more scores and associates the one or more scores with the particular representative.

### RELATED CASE

This case is related to U.S. application Ser. No. ______ [Attorney Docket No. 60352-0178], filed on the same day herewith entitled “USING MACHINE LEARNING TECHNIQUES TO DETERMINE PROPENSITIES OF ENTITIES IDENTIFIED IN A SOCIAL GRAPH” and is incorporated herein by reference as if fully disclosed herein.

### TECHNICAL FIELD

The present disclosure relates to artificial intelligence and digital data processing systems and, more particularly to, analyzing attributes and behaviors of a group of users of a social network service to determine a likelihood that other users of the social network service will perform a particular action. SUGGESTED CLASSIFICATION: 706/12; SUGGESTED ART UNIT: 2121.

### BACKGROUND

A system may spend significant resources on performing actions to achieve a positive result. Such actions are often performed on entities, and the achievement of a positive result often depends on characteristics of those entities. For example, a software update system may spend significant resource on performing a particular update on computing nodes in a data center. Whether an update of a particular computing node is successful depends largely on the characteristics of the computing node, the entity on which the action was performed.

In a system with limited resources and a high likelihood of a negative result, it is extremely critical to minimize the number of actions and, thus, the resources spent on those actions. One way to minimize the number of actions is to accurately predict the result for of the action on entities before performing the action. The prediction of such a result is usually associated with a probability of describing the certainty of attaining the result. The system may then choose to perform actions on some entities for which the result is more likely to be attained, while ignoring other entities for which the result is less likely to be attained. Accordingly, the system has greater efficiency to achieve positive results than by randomly selecting entities to perform actions on.

However, predicting results for entities is computationally intensive, especially when there is a large number of entities. Each entity, for which the result is unknown, needs to be compared with another entity, for which the result is known. With a large number of entities with unknown results, the permutations of comparisons may grow exponentially. Scaling such computations to millions of entities is significantly strenuous for a computer system performing the determination of probabilities.

Nevertheless, even a significantly strenuous computation may be worth the consumption of computing resources, if the accuracy of the prediction result itself will save significantly more resources. For example, when a new software update is to be deployed to a datacenter containing a large number of heterogeneous computing nodes, the resources would be efficiently spent on deploying the update on a small number of computing nodes and then, only deploying the update on those computing nodes of data center that are predicted to have positive results, as long as the predicted results are accurate. An alternative approach of deploying the software update on all computing nodes in the datacenter (perhaps in 1,000's or 10,000's) and monitoring all of those computing nodes performance is very resource intensive. Particularly because the monitoring may uncover that a significant number of nodes are underperforming after the deployment, and the update deployed on the underperforming nodes may need to be rolled back. Such roll backs will consume significant computational resources and cause major disruption for workloads executing in the datacenter.

Another example for which an accurate prediction of results may save substantial critical resources is the allocation of sales resources to accounts in a business organization. The success of a business organization depends largely on the effectiveness of the organization's sales team. At least one aspect that impacts the overall effectiveness of a sales team is the manner in which sales resources—that is, the individual members of the sales team (commonly referred to as sales representatives)—are allocated or assigned to the various customer accounts of the business organization. An accurate prediction of a positive (or negative) result for customer accounts allows the sales resources to be effectively targeted to the appropriate customer accounts and increase the likelihood of becoming a seller of products for the customer represented by the customer account. If the number of customer accounts is several degrees larger than the available sales resources, then the business organization is unable to target each and every account and, even if such methodology is attempted, much of the sales resources may be spent without any tangible result. Accordingly, an accurate prediction of a positive result for a subset of customer accounts based on comparisons of the accounts with unknown results with the known ones would substantially increase the effectiveness of the sales resources.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for managing user profiles and information about organizations, in an embodiment;

FIG. 2 is a flow diagram that depicts an example process for generating an individual propensity score, in an embodiment;

FIG. 3 is a flow diagram that depicts an example process for generating an organization propensity score, in an embodiment;

FIG. 4A is diagram that depicts an example screenshot of a user interface that lists organizations based on organization propensity scores, in an embodiment;

FIG. 4B is diagram that depicts an example screenshot of a user interface that lists individuals that are associated with an organization and factors that were used to generate individual propensity scores for the individuals, in an embodiment;

FIG. 5 is a flow diagram that depicts a process for presenting information about organizations and individuals, in an embodiment;

FIG. 6 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are provided for using social graph data and machine learning techniques to determine a propensity or likelihood that certain users of a social network service (as well as organizations affiliated with the users) will perform a particular action. Factors that are considered for the propensity include profile information that the users provide to the social network service and the users' online behavior with respect to the social network service.

Techniques are also provided for presenting information about organizations and individuals who are likely to perform a particular action. Additionally, the information may include how the propensity of those individuals or organizations to perform the particular action may increase.

### System Overview

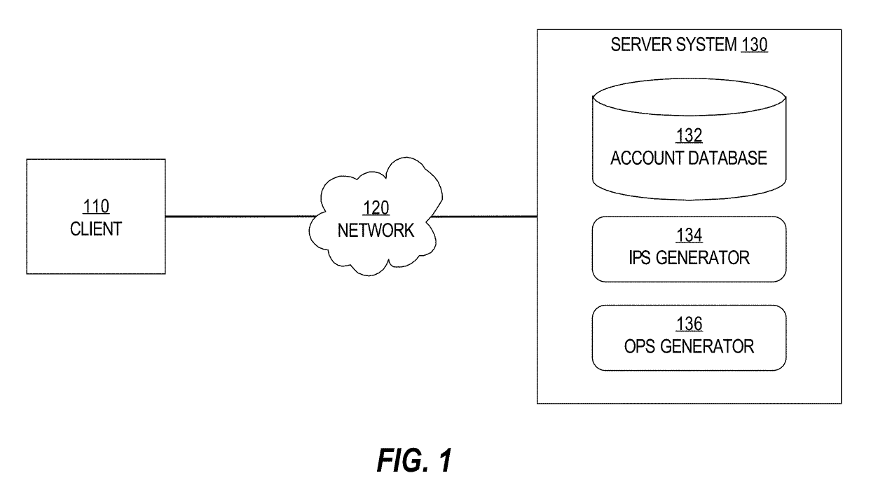

FIG. 1 is a block diagram that depicts a system 100 for managing user profiles and information about organizations, in an embodiment. System 100 includes a client device 110, a network 120, and a server system 130.

Client device 110 is a computing device that is configured to communicate with server system 130 over network 120. Examples of computing devices include a laptop computer, a tablet computer, a smartphone, a desktop computer, and a Personal Digital Assistant (PDA). An example of an application that executes on client device 110 is a dedicated application that is configured to communicate with server system 130 over network 120. Another example of an application is a web application that is downloaded from server system 130 and that executes within a web browser executing on client device 110. Although only a single client device 110 is depicted, system 100 may include multiple client devices that interact with server system 130 over network 120.

Network 120 may be implemented on any medium or mechanism that provides for the exchange of data between client device 110 and server system 130. Examples of network 120 include, without limitation, a network such as a Local Area Network (LAN), Wide Area Network (WAN), Ethernet or the Internet, or one or more terrestrial, satellite or wireless links.

### Server System

Server system 130 is a computer-based system. The various components of the server system 130 are implemented at least partially by hardware at one or more computing devices, such as one or more hardware processors executing instructions stored in one or more memories for performing various functions described herein. For example, descriptions of various components (or modules) as described in this application may be interpreted by one of skill in the art as providing pseudocode, an informal high-level description of one or more computer structures. The descriptions of the components may be converted into software code, including code executable by one or more electronic processors. Server system 130 illustrates only one of many possible arrangements of components configured to perform the functionality described herein. Other arrangements may include fewer or different components, and the division of work between the components may vary depending on the arrangement.

In an embodiment, server system 130 maintains accounts for multiple users. Server system 130 may provide a web service, such as a social networking service. Examples of social networking service include Facebook, LinkedIn, and Google+. A social networking service allows people to register themselves or organizations with the social networking service and allow registered users (and, optionally, non-registered users) access to information of other entities, particularly entities with which the users have established a connection using the social networking service. Server system 130 stores data that may be visualized as a social graph, each node representing an entity and each edge representing a connection between two entities (e.g., users, organizations, groups, etc.). A connection between two entities may be created when one of the entities (or a representative thereof) sends a connection request to the other entity and the other entity (or a representative thereof) accepts.

Although depicted as a single element, server system 130 may comprise multiple computing elements and devices, connected in a local network or distributed regionally or globally across many networks, such as the Internet.

Account database 132 comprises information about multiples accounts, each account corresponding to a different entity, such as users, groups, and organizations. Examples of organizations include government organizations, for-profit companies, non-profit organizations, civic organizations, and religious organizations.

Account database 132 may be stored on one or more storage devices (persistent and/or volatile) that may reside within the same local network as server system 130 and/or in a network that is remote relative to server system. Thus, although depicted as being included in server system 130, each storage device may be either (a) part of server system 130 or (b) accessed by server system 130 over a local network, a wide area network, or the Internet.

In the social networking context, each account in account database 132 includes an entity profile, each provided by a different entity. If the entity is a user, then a profile for the entity may include a first name, last name, an email address, residence information, a mailing address, a phone number, one or more educational institutions attended, one or more current and/or previous employers, one or more current and/or previous job titles, a list of skills, a list of endorsements, and/or names or identities of friends, contacts, connections of the user, and derived data that is based on actions that the candidate has taken. Examples of such actions include applying to jobs, views of job postings, views of company pages, private messages between the user and other users in the user's social network, and public messages that the user posted and that are visible to users outside of the user's social network (but that are registered users/members of the social network provider).

Some data within a user's profile (e.g., work history and academic degrees earned) may be provided by the user while other data within the user's profile (e.g., skills and endorsements) may be provided by a third party, such as a “friend,” connection, colleague of the user.

Server system 130 may prompt users to provide profile information in one of a number of ways. For example, server system 130 may have provided a web page with a text field for one or more of the above-referenced types of information. In response to receiving profile information from a user's device, server system 130 stores the information in an account that is associated with the user and that is associated with credential data that is used to authenticate the user to server system 130 when the user attempts to log into server system 130 at a later time. Each text string provided by a user may be stored in association with the field into which the text string was entered. For example, if a user enters “Sales Manager” in a job title field, then “Sales Manager” is stored in association with type data that indicates that “Sales Manager” is a job title. As another example, if a user enters “Java programming” in a skills field, then “Java programming” is stored in association with type data that indicates that “Java programming” is a skill.

In an embodiment, server system 130 stores access data in association with a user's account. Access data indicates which users, groups, or devices can access or view the user's profile or portions thereof. For example, first access data for a user's profile indicates that only the user's connections can view the user's personal interests, second access data indicates that confirmed recruiters can view the user's work history, and third access data indicates that anyone can view the user's endorsements and skills.

In an embodiment, some information in a user profile is determined automatically by server system 130 (or another automatic process). For example, a user specifies, in his/her profile, a name of the user's employer. Server system 130 determines, based on the name, where the employer and/or user is (or might be) located, such as a database of known offices of multiple organizations. If the employer has multiple offices, then a location of the user may be inferred based on an IP address associated with the user when the user registered with a social network service (e.g., provided by server system 130) and/or when the user last logged on to the social network service.

### Propensity Score

Techniques are described herein for generating a score that indicates (a) a likelihood that an entity is to perform a particular action or (b) a propensity to perform the particular action. Such a score is referred to herein as a “propensity score.” An entity may be an individual or an organization. The particular action may be one of many types of actions, such as signing up for a webinar, purchasing a particular product or service, subscribing for a news feed, and clicking on a particular content item that is displayed to a user. The action may be relative to the social network service or the social network provider that provides the social network service.

Propensity scores may be used by the social network provider (i.e., that provides server system 130) to know who and/or how to target members (both individuals and organizations) of the social network service. Additionally or alternatively, propensity scores may be used by an entity that is different than the social network provider, such as organization that uses one or more services provided by the social network provider, to know who and/or how to target customers or potential customers of the entity.

### Machine Learning

In an embodiment, a propensity score is generated using one or more machine learning techniques. A machine learning technique involves generating a statistical model that is trained based on a history of actions and attributes of known entities. The statistical model is trained based on multiple factors described herein. In machine learning parlance, such factors are referred to as “features.” To generate and train a statistical model, a set of features is specified and a set of training data is identified.

For example, a group of people affiliated with a social network provider may have attempted to persuade 98 individuals to perform a particular action (such as purchasing a particular product). 31 of the 98 individuals performed the particular action and 67 individuals did not. For each result, whether positive or negative, a set of values corresponding to the set of features is determined. The 98 results and the set of values of each result are used to train a statistical model.

Embodiments are not limited to any particular machine learning technique for generating a statistical model. Example machine learning techniques include logistic regression and random forests.

In an embodiment, multiple statistical models are trained to generate a propensity score, one for a different set of entities. For example, one statistical model is used to generate propensity scores for individuals from the United States, another statistical model is used to generate propensity scores for individuals from Japan and Korea, and another statistical model is used to generate propensity scores for native English speakers that are currently residing outside the United States. Additionally or alternatively to geography, other grouping criteria may be used to group registered users of server system 130, such as demographic criteria, education level, current industry, size of organization, job classification, and number of connections.

In an alternative embodiment, instead of using machine-learning techniques to generate a propensity score, one or more non-machine learning techniques are used to generate a propensity score. For example, a value for each propensity factor is first normalized (e.g., to a value between a value between 0 and 100) and then the normalized values are combined, such as summing, averaging, etc. Before combining, the normalized values may be weighted differently. For example, a number of hires that an organization made in one year may be weighted higher than a number of online connections that employees of the organization have in a social network.

### Individual Propensity Factors

Server system 130 includes an individual propensity score (IPS) generator 134 that analyzes data about multiple users of a social network service. The data may include profile data that the users provided to the social network service and/or activity data that indicates activities or actions that the users have initiated relative to the social network service. IPS generator 134 is implemented in software, hardware, or any combination of hardware and software.

Multiple factors may be considered in generating an IPS for an individual member or user of a social network service. The factors that are considered may change depending on the particular action that is being predicted and the target audience. For example, sales professionals may behave differently than marketing professionals. Therefore, the attributes and/or behaviors that are used to generate IPSs for sales professionals may be different than the attributes and/or behaviors that are used to generate individual propensity scores (IPSs) for marketing professionals.

The following description provides details about multiple factors. Not all of the following factors may be considered when generating a single IPS. Instead, a strict subset of the factors may be used. Furthermore, different IPSs for different users may be based on a different set of factors.

### Individual Propensity Factor: Job Function

In an embodiment, a job function of an individual is a factor in generating an IPS for the individual. Example job functions include sales functions, entrepreneurs, and business development functions. If an individual is associated with one of these job functions, then all else being equal, the individual will have a higher IPS. Some of these job functions may have higher effect on IPSs than others. Thus, for example, the more the job function of an individual is related to selling products or services, the higher the IPS for that individual. For example, all else being equal, sales professionals and account executives may have higher IPSs than individuals with other job functions. In a related embodiment, a level of seniority of an individual within an organization is a factor in generating an IPS for the individual. The higher the level of seniority, the higher the IPS. The level of seniority may be specified in a job title of the individuals (e.g., “CEO”, “VP”, or “Manager”) or may be derived based on the job title.

A job function may have been specified by the individual, for example, when the individual created an online profile using client device 110 and server system 130. Alternatively, server system 130 derives a job function based on input from the individual, such as a job title. Example job titles for sales functions include Account Executive, Account Manager, Sales Development, Sales Representative, and Account Director. Example job titles for sales operations roles include Sales Operations Analyst, Sales Systems Specialist, Account Analyst, and Sales Strategist. If the individual specifies multiple job titles, then server system 130 may select the most recently added job title or the job title that is indicated as the individual's “current” job title.

Server system 130 may store a mapping that maps job titles to job functions. The mapping may have been created manually based on a human understanding of job titles and their associated job functions. Alternatively, the mapping may be created by one or more machine learning algorithms based on common language and taxonomy.

### Individual Propensity Factor: Profile View

In an embodiment, a number of profile views that an individual requests or initiates is a factor in generating an IPS for the individual. The greater the number of profile views, the higher the IPS. A profile view request may be of an individual or of an organization, such as a company, a civic organization, a government organization, etc. Each type of profile view request may be tracked separately; for example, number of individual profile views and number of organization (or “company”) profile views. Also, different weights may be given depending on whether a profile view request is for a user's profile or a company's profile. Each type of profile view request indicates a different signal. Viewing a company's profile may be associated with an intent to learn more about the company and the people who work there. Viewing a user's profile, on the other hand, is a deeper, more directed search.

Each time an individual uses his/her client device (e.g., client device 110) to send a profile view request over network 120 to server system 130, server system 130 records the profile view request in association with an account of the individual, which account may be stored in account database 132. Thus, if an individual submits 12 profile view requests to server system 130, then server system 130 stores, in association with the individual's account, profile view request data that indicates that the individual submitted 12 profile view requests.

In a related embodiment, profile view requests are “aged out” over time. For example, the factor that is used to generate an IPS for an individual is the number of profile view requests that the individual submitted over the last 30 days. Thus, any profile view requests that the individual submitted more than 30 days prior to generation of the IPS for the individual are ignored.

In a related embodiment, IPS generator 134 differentiates between multiple types of profile view requests. One type of profile view request is “out-of-network” and another type of profile view request is “in-network.” An “in-network” profile view request is “in-network” with respect to the social network provider that provides server system 130. Thus, an “in-network profile view request is one in which the initiating individual submits the profile view request using an application (e.g., a mobile application) or a web page (e.g., rendered in a web browser executing on client device 110) provided by the social network provider. For example, an individual may be viewing her own profile page provided by the social network provider. The profile page includes a list of other individuals that the social network provider determines the individual might know. If the individual selects a link associated with one of the individuals in the list, then client device 110 sends a profile view request that indicates the “selected” individual and server system 130 records the profile view request in association with the selecting individual and stores data that indicates that the profile view request is an in-network request.

An out-of-network profile view request is one in which an individual initiates the profile view request through an application or web page that is provided by an entity that is different than the social network provider that provides server system 130. For example, an individual submits search criteria in a search field of a web page provided by a search engine that is provided by an entity that is different than the entity that provides server system 130. A search results page includes a link to profile page of a company or individual that satisfies (at least partially) the search criteria. The profile page is maintained by server system 130. If the individual selects the link, then client device 110 submits a request over network 120 to server system 130. Server system 130 receives the request and determines that the request is coming from outside of server system 130's ecosystem or from a web page that is provided by a different entity.

In an embodiment, an out-of-network profile view request has a higher positive effect on an IPS (of an individual that initiates the request) than an in-network profile view request that the individual initiates. Thus, generally, individuals who initiate more out-of-network profile view requests are more likely to perform the particular action that is being predicted. For example, all else being equal, if a first individual has initiated 4 out-of-network profile view requests and 6 in-network profile view requests and a second individual has initiated 3 out-of-network profile view requests and 7 in-network profile view requests, then the first individual will have an IPS that is higher than an IPS generated for the second individual, even though both individuals initiated the same overall number of profile view requests.

### Individual Propensity Factor: Searching

In an embodiment, searching is a factor in generating IPSs for individuals. Generally, the more searches that an individual initiates using server system 130, the higher the IPS. When an individual initiates a search that server system 130 performs, server system 130 stores search data that indicates that the individual initiated a search. This data may be stored in an account, for the individual, in account database 132. The search data for an individual may indicate when each search was performed and/or may include a counter that increments for each search that the individual initiates.

In a related embodiment, searches are “aged out” over time. For example, the factor that is used to generate an IPS for an individual is the number of searches that the individual initiated over the last 60 days. Thus, any searches that the individual initiated more than 60 days prior to generation of the IPS for the individual are ignored.

In an embodiment, server system 130 supports multiple types of searches. One type of search may be a people search where an individual specifies one or more search criteria and submits the search criteria for identifying one or more users who satisfy the search criteria. Example search criteria that a user must satisfy (at least partially) in order to be identified in a search result include a job title, a degree of separation from the individual initiating the search (e.g., within 3 degrees of separation), one or more skills, a number of endorsements, a number of connections, a number of years of post-graduate education, and a former employer.

Another type of search that server system 130 may support is a company search, which is a search for companies or other organizations that satisfy one or more company criteria. Example company criteria include a geographical location of a company, a number of offices that a company has, a number of employees of a company, a number of job openings at a company, a stock price of a company, and a specific job title or job function for which a company hires.

Another type of search that server system 130 may support is a job search, which is a search for job openings from one or more organizations. Organizations may provide information about job openings to server system 130, which posts the job openings such that a job search that includes criteria that a job opening satisfies will result is displaying the job opening. Additionally or alternatively, server system 130 performs a Web crawl operation relative job pages of organizations (where the job pages are provided by those organizations) for job opening data, extracts job opening data from the job pages, and stores the extracted job opening data in a local repository. Additionally, an organization may have its own organization or company page that server system 130 hosts and that includes a list of job openings or a link to a list of job openings.

An individual initiating a job search may specify job criteria and/or company criteria. Example job criteria include a job title of a job opening, a job function associated with a job opening, one or more skills required by a job opening, a geographical location of a job opening. If a job search includes both job criteria and company criteria, then the job criteria may be used to identify a set of job openings that satisfy the job criteria and then company criteria is used to filter the set of job openings. Alternatively, the company criteria may be used to identify a set of job openings that satisfy the company criteria and then the job criteria is used to filter the set of job openings.

If server system 130 supports multiple types of searches, then server system 130 records the type of search in association with the individual that initiated the search. For example, each individual's account includes a count for each type of search that the individual initiates. Thus, one individual's account may indicate a count of 5 for people searches, a count of 4 for company searches, and a count of 13 for job searches while another individual's account may indicate a count of 31 for people searches, a count of 2 for company searches, and a count of 0 for job searches.

In an embodiment, different types of searches that an individual initiates have a different effect on an IPS that is generated for the individual. For example, a company search may have a higher positive effect on an IPS for an individual than a people search. As another example, a job search may have a negative effect on an IPS for an individual. Thus, all else being equal, the more job searches an individual initiates, the lower an IPS for that individual. A relatively high number of job searches initiated by an individual may indicate that the individual is more interested in changing jobs than in performing the particular action that is being predicted.

### Individual Propensity Factor: Tenure

In an embodiment, a tenure of an individual in his current employment position is a factor in generating an IPS for the individual. “Tenure” refers to an amount of time that an individual has a particular employment position, which may be a self-employed position or as an employee at a particular employer (or particular company). Tenure may be a consecutive amount of time or a total amount of time. For example, if (1) an individual is at company A for the calendar years 2013, 2015, and 2016 and at company B for calendar year 2014 and (2) an IPS is generated at the end of calendar year 2016, then the individual's tenure may be 2 years (consecutive) or 3 years (total).

An individual's tenure may or may not take into account job position but may instead consider just employer. For example, if an individual has held multiple consecutive positions within the same employer, then the individual's tenure would the total time employed by that employer.

The longer an individual's tenure at his/her current employment position, the lower the individual's IPS is. In other words, the longer that an individual is at his/her current company, then the less likely the individual is at performing the particular action that is being predicted. For example, if the particular action is purchasing a particular product or service provided by the entity that provides server system 130, then an individual with a relatively long tenure is less likely to perform that action.

An individual's tenure may be calculated by analyzing the individual's profile, which indicates a current position and a start date of the current position. The tenure is calculated by subtracting the current date (e.g., Nov. 20, 2017) with the start date of the current position (e.g., Mar. 16, 2015). If a total tenure time is calculated, then an individual's tenure is calculated as above and then it is determined whether the individual had the same position (or different position) with the same employer previously. If so, then the amount of time that the individual was working at the same position (or different position) with that employer is added to the difference between the current date and the start date of the individual's current position.

### Individual Propensity Factor: Address Book

In an embodiment, an individual's address book related activity is a factor in generating an IPS for an individual. Address book related activity may refer to one or more types of online behavior. An example of address book related activity include an individual causing an address “book” (or a set of email addresses) to be uploaded (e.g., from client device 110) to server system 130. In response, server system 130 may send connection invitations to email accounts associated with the email addresses or to online accounts maintained by server system 130 if some of the email addresses are registered with server system 130.

In an embodiment, when an address book upload occurred is a factor in generating an IPS. The more recent the address book upload, the lower the IPS. Thus, address book uploads that occurred in the relatively distant past (e.g., over a year has passed) may not have any negative impact on IPS. Thus, server system 130 tracks when address book uploads occur. Upload data may be stored in (or in association with) an individual's account in account database 132. Server system 130 updates upload data that is associated with an individual when server system 130 determines that the individual has uploaded an address book.

In an embodiment, an individual's account in account database 132 includes an address book or list of people that the individual may know. The address book may include email addresses, phone numbers, and/or user indicators that indicate other individuals. An individual may request to view his/her address book when the individual desires to communicate with an individual indicated in the address book. An individual's selection of a user indicator may cause a message form to be displayed to allow the individual to construct and send a message. If the intended recipient of the message has an account with server system 130, then the message does not need to be sent over a network external to server system 130 in order to deliver the message to the intended recipient's account.

In an embodiment, server system 130 tracks a number of times an individual visits, requests, or retrieves his/her address book that server system 130 maintains. The more times an individual requests or otherwise views his/her address book, the higher an IPS for the individual. In other words, continually visiting an address book may be correlated with an individual's propensity or likelihood to perform the particular action.

In a related embodiment, address book views are “aged out” over time. For example, the factor that is used to generate an IPS for an individual is the number of address book views that the individual requested (i.e., from server system 13) over the last 45 days. Thus, any address book views that the individual requests more than 45 days prior to generation of the IPS for the individual are ignored.

### Individual Propensity Factor: Endorsements

In an embodiment, a number of endorsements associated with an individual is a factor in generating an IPS for the individual. Server system 130 may provide the ability for individuals that are registered with server system 130 to endorse one another. For example, a first individual viewing a profile page of a second individual selects an endorsement graphical element (e.g., link or button). In response, server system 130 stores endorsement data that indicates that the first individual endorses the second individual. The endorsement data may then be viewed by other individuals that view the profile page of the second individual. Additionally, server system 130 may “push” or send the endorsement data to friends or connections of the second individual and/or of the first individual. Additionally or alternatively to immediately storing endorsement data, server system 130 may provide an interface into which the first individual can enter characters that constitute an endorsement. In this way, an endorsement is more than a simple unary indication that an endorsement exists; it explains why one individual (in his/her own words) is endorsing another.

In an embodiment, server system 130 tracks both a number of endorsements that an individual receives and a number of endorsements that the individual makes of others. Receiving endorsements and making endorsements may have the same effect on an IPS for an individual. For example, all else being equal, an individual that receives 11 endorsements and makes 6 endorsements will have the same IPS as an individual that receives 15 endorsements and makes 2 endorsements. Alternatively, receiving and making endorsements have a different effect on an IPS for an individual. For example, making endorsements may have a higher positive effect on an individual's IPS than receiving endorsements.

In a related embodiment, similar to other factors described herein, endorsements are “aged out” over time. For example, the factor that is used to generate an IPS for an individual is the number of endorsements that the individual has made and/or received over the last year. Thus, any endorsements that the individual made or received more than 1 year prior to generation of the IPS for the individual are ignored or weighted less than more recent endorsements.

### Individual Propensity Factor: Applying for Jobs

In an embodiment, server system 130 allows registered individuals to apply for job openings that server system 130 lists. For example, an employer uses server system 130 to post a job opening. An individual, operating client device 110, causes a request to be sent to server system 130 to view details of the job opening, which may be listed on a jobs page associated with an account of the employer. The individual may then provide, to client device 110, input that causes a job application request to be sent to server system 130, which sends, to the employer, job application data that indicates that the individual is applying to a particular job that the employer has listed. The job application data may be sent to an email account of the employer, another computer system maintained by the employer, or to an online account maintained by server system 130. Server system 130 also creates job application data that indicates that the individual applied the job opening and stores the job application data in association with an account of the individual. In this way, server system 130 tracks how often (and, optionally, when) each individual applies for a job through the platform of server system 130. Thus, each individual's account (in account database 132) may indicate a number of times the individual initiated a job search.

In an embodiment, the greater the number of times an individual applies for one or more job openings, the lower the individual's IPS. A relatively high number of jobs openings for which an individual has applied may indicate that the individual is more interested in changing jobs than in performing the particular action that is being predicted.

In a related embodiment, similar to other factors described herein, job applications are “aged out” over time. For example, the factor that is used to generate an IPS for an individual is the number of job openings that the individual has for over the last 6 months. Thus, any job openings for which the individual has applied more than 6 months prior to generation of the IPS for the individual are ignored or weighted less that more recent job applications.

### Individual Propensity Factor: Education

In an embodiment, an individual's education is a factor in generating an IPS for the individual. Total education may be one metric, where “total education” refers to a number of different education entries that an individual includes in his/her profile. An education entry includes information about a single academic institution and, optionally, an amount of time that was spent at the academic institution. For example, an individual may provide input for three education entries: one for high school (or secondary school), one for an undergraduate institution, and another for a graduate institution that s/he attended.

In an embodiment, the more the total education of an individual (or the higher the number of education entries), the lower the IPS is for the individual. This inverse relationship (similar to other relationships between factors and IPS) may be learned automatically or manually by analyzing factors of individuals who have performed the particular action that is being predicted and, optionally, individuals who have not performed the particular action.

### Individual Propensity Factor: Reading Articles on Social Network Platform

In an embodiment, server system 130 allows registered individuals to view articles that are available on server system 130. The articles may have been composed by registered users of server system 130, employees of the associated social network provider, and/or third-party publishers, such as different news outlets. Server system 130 may provide a web page that registered individuals may request and that lists articles for viewing. Additionally or alternatively, server system 130 provides each registered individual an individualized home page that includes a section that contains one or more abstracts of one or more articles. The section may be implemented as a newsfeed through which a user may scroll while, for example, other contents of the home page remain stationary.

Additionally or alternatively to web pages, server system 130 may interact with registered individuals through dedicated (e.g., mobile) applications that are executing on client devices of registered individuals. Whichever mechanism is used to allow individuals to request and view articles, server system 130 records when an individual provides input to request to view a specific article.

In these embodiments, server system 130 tracks a number of articles that an individual requests over a period of time, such as the time the individual has been registered with server system 130 or the last 6 months. The greater the number of articles an individual requests over the period, the higher an IPS for that individual.

In a related embodiment, server system 130 records a date when each request to view an article was submitted. Later, when requests to view articles are used as a factor in generating an IPS for an individual, the dates associated with the requests may be used to weigh or ignore some requests. Thus, older requests to view articles may have a smaller positive effect on individual propensity scores than relatively new requests to view articles.

### Individual Propensity Factor: Scrolling Through a News Feed

In an embodiment, server system 130 provides a news feed feature (e.g., in a mobile application or a web application) that allows registered individuals to view multiple content items and scroll through a list of content items, which list may be too long to fit on a screen of a computing device, even a relatively large screen. Examples of content items include a text snippet and image from an article (that can be requested by selecting the content item), an advertisement, a text snippet from a blog posting of a “friend” or connection, and a comment that a connection made on another article that the content item might reference.

In this embodiment where individuals are allowed to scroll through news feeds, server system 130 tracks how often and/or how long each individual scrolls through a news feed. The more an individual scrolls through a news feed, the lower an IPS for that individual. If an individual performs no scrolling through news feeds or performs relatively little scrolling (e.g., less than 20 minutes per week and/or less than four login sessions), then an IPS for that individual may not be negatively impacted.

### Individual Propensity Factor: Connections

In an embodiment, a factor in generating an IPS for an individual is a number of connections that the individual has made in a social network hosted by server system 130. The number of connections may be a positive indicator in the individual's propensity to perform the particular action. A connection between two individuals is created when one individual causes a connection invitation message to be sent to another individual through server system 130. The connection invitation message may be displayed to the recipient on a web page provided by server system 130 or in an application (executing on the recipient's computing device) provided by the entity that owns or maintains server system 130. If the recipient accepts, then a connection is established. The connection may be indicated in the accounts (in account database 132) of both individuals.

In a related embodiment, more recently established connections may be weighted differently (e.g., higher) than “older” connections. Thus, each connection may have a creation date that indicates when the connection was formed or established. Server system 130 uses a connection's creation date to determine whether to use (or how much to weigh) the connection when generating an IPS for the corresponding individual.

In an embodiment, different types of connections are weighted differently when generating an IPS for an individual. For example, a first connection to a sales vice president may be weighted higher than a second connection to an entry-level engineer, which will cause the IPS to be higher, indicating that the individual that made the first connection is more likely to perform the action. Thus, all else being equal between two individuals, if a first individual has one or more connections that are weighted higher than one or more other connections that a second individual has, then the first individual will have a higher IPS than the second individual.

### Generating an Individual Propensity Score

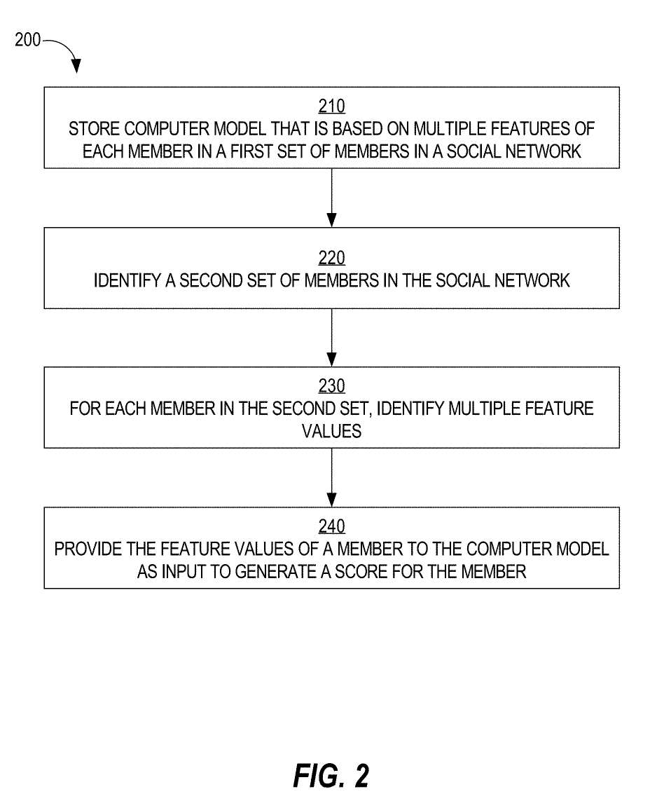

FIG. 2 is a flow diagram that depicts an example process 200 for generating an individual propensity score, in an embodiment. Server system 130 implements process 200. Although depicted and described as comprising four blocks, process 200 may be performed with more blocks and each block may comprise of multiple blocks or steps.

At block 210, a statistical (or computer) model that is based on multiple factors (or features) of each member in a first set of members of a social network is stored. The model is generated by the social network provider or by a third party relative to the social network provider.

The factors include one or more factors that pertain to profile information that the first set of members provided and that is stored in profiles of the members. For example, the one or more factors include a job title, an industry, a number of connections to other registered members of the social network, and tenure of a current employer.

The factors also include one or more factors that pertain to search information about searches that were initiated by the members and performed by the social network provider.

At block 220, a second set of members of the social network provider is identified. Such members include at least one member that is not included in the first set of members. The second set of members may be identified by searching a social graph maintained by the social network provider using one or more search criteria, such as one or more specific job titles (some of which may map to one or more specific job functions, such as marketing or sales), and/or or employment status.

At block 230, for each member in the second set, a set of factor (or feature) values is identified. The set of features that correspond to the set of feature values is the same as those upon which the model is trained.

Block 230 may involve determining a number of searches that each member initiated and that are of a particular type, such as people searches, company searches, or job searches. Additionally or alternatively, block 230 may involve determining a seniority, a tenure, a job function, and/or a total number of academic institutions listed associated with each member.

At block 240, the set of feature values of a member is provided to the model as input to generate a score for the member. Thus, block 240 is performed a number of times that is equal to the number of members in the set identified in block 220. The score indicates a likelihood that the corresponding member will perform a particular action, such as purchase a product or service offered by the social network provider.

### Organization Propensity Factors

Organizations may also have propensities to perform the particular action. However, not only are organizations different than individuals in obvious ways, organizations may have different markers (or hints) that indicate their respective propensities to perform the particular action. Thus, different factors may be used to generate a propensity score for organizations than are used to generate propensity scores for individuals. A propensity score for an organization is referred to herein as an “organization propensity score” or OPS. Thus, server system 130 includes an organization propensity score (OPS) generator 136. Like IPS generator 134, OPS generator 136 is implemented in software, hardware, or any combination of hardware and software. For some OPS factors, profiles of affiliates of an organization are analyzed and attribute values from the profiles are aggregated to generate a single factor/feature value for the organization. Examples of such attributes values are described hereafter.

### Organization Propensity Factor: Connections

In an embodiment, a number of connections that affiliates (e.g., employees) of an organization have is a factor in generating an OPS for the organization. In this embodiment, server system 130 identifies affiliates from each of multiple organizations. The more connections that affiliates of an organization has, the higher the OPS of the organization, at least in a certain range.

An affiliate of an organization may be identified by analyzing profiles of registered users of server system 130 and determining whether the profiles specify the organization as the corresponding user's current employer. If an individual's profile specifies multiple employers, then a current employer may be inferred by being the top-most employer listed in the profile or by analyzing date information that is associated with each employer designation. For example, a profile includes a work history that may comprise multiple employment entries, each employment entry including information about a job position that the corresponding individual held. An employment entry may specify a hire or start date and a departure or end date. If no departure date is specified, then the corresponding employer is a candidate as the current employer of the individual. Additionally or alternatively, an employer specified in an employment entry with the latest start date is a candidate as the current employer of the individual.

Thus, in order to calculate the total number of connections of affiliates of an organization, current affiliates are identified based on analyzing their respective profiles and, for each employee, a number of connections that the employee has in a social network is determined. Lastly, the number of connections of each affiliate of the organization is summed to calculate the total number of connections associated with the organization. The total number may be a factor in generating an OPS for the organization.

In a related embodiment, a number of connections from affiliates (e.g., employees) of an organization to affiliates (e.g., employees) of the social network provider is calculated and used to generate an OPS for the organization. Affiliates of the organization may be identified in the same way described previously. For each identified affiliate of the organization, a number of connections to affiliates of the social network provider is determined. For example, employee A of an organization has 4 connections to the social network provider and employee B of the organization has 9 connections to the social network provider. Thus, if employees A and B are the only employees of the organization, the total number of connections associated with the organization to employees of the social network provider is 4+9=13.

Some of the connections may be to the same provider-affiliate, which may or may not be considered when generating an OPS for an organization. For example, 2 of the 9 connections of employee B may be the same as 2 of the 4 connections of employee A. In this case, the organization would be associated with 11 unique connections to employees of the social network provider. An OPS generated for the organization may be higher than an OPS generated for a second organization if, all else being equal, employees of the organization has more unique connections to employees of the social network provider than employees of the second organization.

### Organization Propensity Factor: Followers

In an embodiment, server system 130 allows users to “follow” different organizations. A “follower” of an organization is a user who receives updates and other information about the organization. For example, if server system 130 detects that an organization is mentioned in a prominent news article, then, if a user is a registered follower of the organization, server system 130 will send information about the article to the user, such as a text message, an email message, or a message in an account that server system 130 maintains. The more followers an organization has, the higher its OPS.

In a related embodiment, followers that are known to be employees of (or otherwise affiliated with) an organization are filtered from the total number of followers of the organization, which number is used to generate an OPS for the organization. For example, an organization may have a hundred followers, but each of those followers is an employee of the organization. In this example, the total number of “real” followers of the organization would be zero.

### Organization Propensity Factor: Purchase History

In an embodiment, the entity that provides server system 130 tracks purchase history that is associated with an organization. Different members or employees of the organization may have purchased products or services from the entity in the past. Purchase history may include a number of purchases (e.g., one employee may have made 5 purchases), a number of employees who made a purchase (e.g., ten different employees may have made at least one purchase), who the purchasers were (e.g., job title, demographic information), and/or what products or services were purchased. The more purchases by an organization, the higher the OPS for the organization. Similarly, the more employees of an organization who initiated a purchase, the higher the OPS for the organization. Additionally, the higher the certain percentage or number of employees of an organization who made a purchase have a job title or job function in a particular set of job titles or job functions, the higher the OPS for the organization. For example, employees of an organization who have made a purchase and have a job title of “sales representative” may have a higher positive effect on the OPS for the organization than employees who a different job title or job function.

If the particular action that is being tracked is a purchase of a particular product, then purchase history pertaining to the particular product is more relevant than purchase history pertaining to another product or service. Thus, all else being equal, if one organization spent X on the particular product and another organization spent X on another product from the same entity, then the first organization will have a higher OPS.

### Organization Propensity Factor: Company Growth

In an embodiment, growth in number of employees (and/or independent contractors) of an organization is a factor in generating an OPS for the organization. The growth may be over any time period, such as the last three months, 1 year, or 10 years. Information on growth may be derived based on public sources that report a number of employees and other individuals associated with an organization (e.g., a publicly-held company) at different time periods. For example, server system 130 determines that the number of employees of an organization at the beginning of 2015 is 10,324 and the number of employees of the organization at the beginning of 2016 is 13,976. Thus, the growth is 3,652 employees in one year.

Alternatively, growth of an organization may be determined by determining a number of employees of the organization that are registered with server system 130 at time A and a number of employees of the organization that are registered with server system 130 at time B, which numbers may be determined using techniques described previously (i.e., analyzing user profiles to determine current employers).

As a factor, growth may be an absolute number or a relative number. In the example above, the absolute number is 3,652 while the relative growth is 3,652/10,324 or 35%. Regardless of which metric is used, the higher an organization's growth, the higher the organization's OPS.

In an embodiment, growth of an organization where employers were hired using services (e.g., job listings) provided by server system 130 is a factor in generating an OPS for the organization. For example, server system 130 records when an individual views a job opening listing (of an organization) provided through server system 130. Server system 130 then determines that the individual joined the organization after the viewing of the job opening listing. The individual may have personally contacted a representative of the organization before or after viewing the job opening listing, but it may be presumed that the individual learned about the organization through server system 130.

The more employees of an organization that were hired using server system 130, the higher the organization's OPS. Growth of an organization using employment services provided by server system 130 may have a higher positive effect on OPS for the organization than simple growth of the organization.

### Organization Propensity Factor: Job Title/Function

In an embodiment, the entity that provides server system 130 uses job information related to an organization's employees as a factor in generating an OPS for the organization. The job information includes a job title or job function of an employee. Such job information may be retrieved from each employee's profile (e.g., stored in account database 132). Individuals with certain job titles/functions may be more inclined to perform the particular action that is being predicted. Thus, the more employees that have the job title(s)/function(s), the higher the OPS for the associated organization. For example, the more employees of an organization who have a job title of “sales representative,” the higher a positive effect on the OPS for the organization. Such employees may be more likely to purchase the product or service that the entity is attempting to sell.

### Organization Propensity Factor: Subscribers

In an embodiment, the entity that provides server system 130 also provides one or more software tools or special data access to which some registered users subscribe. Such a tool/data access may only be available to those who pay a fee, such as a one-time fee or a monthly/yearly subscription.

In this embodiment where the social network provider allows users to subscribe to a software tool or special data access, server system 130 determines, for each organization for which an OPS is to be generated, a number of employees that are (or were) subscribers. The greater the number of employees of an organization who are also subscribers to tools(s)/data, the higher the OPS for the organization. Subscribing to the software tool or special data access may be the very action that is being predicted with the OPS.

### Organization Propensity Factor: Interest Indicators

In an embodiment, the entity that provides server system 130 tracks one or more individual activities that indicate interest in the entity. Examples of such activities include signing a contact-me form, submitting a request for a demonstration, signing up for a webinar, and attending a live event and leaving contact information (e.g., an email address). Some activities may be performed using a computing device while others may be performed with a pen and paper. Some activities may be weighted higher than others such as signing a contact-me form versus signing up for a webinar.

Server system 130 aggregates the activities of affiliates (e.g., employees) of an organization (e.g., sums the activities where each activity equals “1”) and uses the aggregated value as a factor in generating an OPS for the organization. The higher the aggregated value of an organization, the higher the positive effect on an OPS for the organization.

### Organization Propensity Factor: Social Network Metrics

In an embodiment, one or more social network metrics of affiliates (e.g., employees) of an organization are tracked and used to generate an OPS for the organization. Example metrics of an affiliate include a level of completeness the affiliate's social network profile, a number of connections of the affiliate, a number of searches that the affiliate performs, a number of social network groups joined, a number of comments submitted, a number of posts “liked”, and a number of posts shared.

Regarding profile completeness, a member's profile (e.g., stored in account database 132) comprises multiple fields or entries. Example fields include name, residence information, job title, current employer, previous work history, industry, academic institutions attended, skills, photo, and interests. In order to register with server system 130, a member does not have to provide information for each field or entry in the profile. However, the more fields or entries for which a member provides information, the higher the OPS for the member's employer organization. Some fields or entries may have a higher weight than others. For example, the photo field may have the highest weight relative to other fields. Thus, a member who has 25% of her profile completed, including a photo of the member, may have a higher positive effect on the member's employer organization than a member who has completed 75% of his profile and did not include a photo of himself.

In an embodiment, at least a subset of these social network metrics are used to generate a score, referred to herein as a social selling index (SSI). An SSI is generated for each of multiple employees of an organization for which an OPS is being generated. SSIs associated with the organization may then be aggregated (e.g., summed, averaged, or percentile calculated) and used as a factor in generating the OPS. For example, the higher the average SSI of employees of an organization, the higher the OPS for the organization.

SSI generation may be limited to certain affiliates, such as employees with certain job titles, functions, and roles. For example, an SSI is generated only for employees who have specified “sales representative” as their job title or a job title that has been associated with a sales representative position, such as “sales manager.” Thus, employees who have a different job title (e.g., “Product Manager” or “Software Engineer”) will not be associated with an SSI.

### Generating an Organization Propensity Score

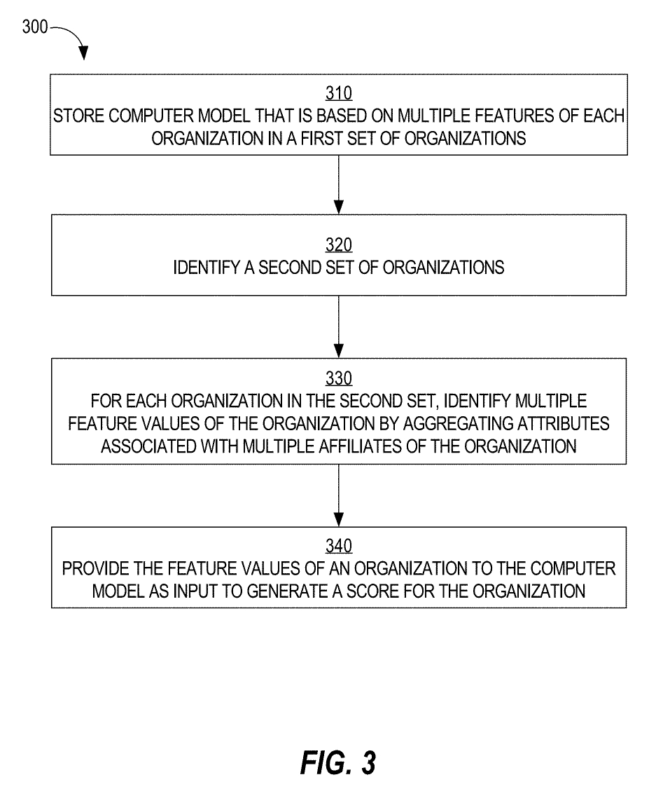

FIG. 3 is a flow diagram that depicts an example process 300 for generating an organization propensity score, in an embodiment. Server system 130 implements process 300. Although depicted and described as comprising four blocks, process 300 may be performed with more blocks and each block may comprise of multiple blocks or steps.

At block 310, a statistical (or computer) model that is based on multiple factors (or features) of each organization in a first set of organizations is stored. The model is generated by the social network provider or by a third party relative to the social network provider.

The factors include one or more factors that pertain to profile information that affiliates (e.g., employees, representatives, etc.) of the organizations provided and that is stored in profiles of the affiliates. For example, the one or more factors includes a job title, an industry, a number of connections to other registered individuals of the social network, and/or any combination of the factors described above.

At block 320, a second set of organizations of the social network provider is identified. Such organizations include at least one organization that is not included in the first set of organizations. The second set of organizations may be identified by searching a listing of organizations, which listing may have been generated manually or automatically based on one or more search criteria, such as industry the organization is in, geographical location of one or more offices of the organization, and/or size of the organization.

At block 330, for each organization in the second set, a set of factor (or feature) values is identified. The set of features that correspond to the set of feature values are the same as the set of features upon which the model is trained.

Block 330 involves identifying a set of profiles of a set of affiliates (e.g., employees), each affiliate corresponding to a different affiliate of an organization in the second set. Then, attributes values of the set of affiliates are identified, where each attribute value corresponds to a different affiliate in the set. The attributes values are of an attribute of the affiliates, which attribute is a factor in generating an OPS or a feature in the model. Then the attribute values are aggregated to generate an aggregated attribute value, which is one of the feature values identified in block 330.

Block 330 may involve performing multiple aggregation operations (e.g., sum, count, mean, median) for a single organization. Thus, multiple feature values in the set of feature values may be the result of an aggregation operation.

At block 340, the set of feature values of an organization is provided to the model as input to generate a score for the organization. Thus, block 340 is performed a number of times that is equal to the number of organizations in the set identified in block 320. The score indicates a likelihood that the corresponding organization (or an affiliate thereof) will perform a particular action, such as purchase a product or service offered by the social network provider.

### Value Scaling

Before a value of a factor or feature is used to train a model or generate a propensity score, the value is scaled or normalized. Because using the value directly would skew modeling and a propensity score, the value is scaled. For example, if the value represents a dollar amount, the dollar amount itself cannot be used to create a model. This is because the dollar amount may be very high, which, if directly used to create a model, will give the corresponding factor outsized importance relative to other factors. In these cases, the value is scaled. The scale may be a 0-1 scale, 0-100 scale, or any other scale.

In an embodiment, a normalized value is generating by first determining a maximum value (max_value) and a minimum value (min_value) in a set of non-normalized values. Then, for each non-normalized value in the set, the minimum value (min_value) is subtracted from the non-normalized value and the result is divided by the difference between the maximum value and the minimum value (max_value−min_value). For example, if company growth is a factor and the set of known company growths of different companies is {(−1,324), 4, 298, 10,174)}, then the corresponding set of normalized values would be {0, 0.115, 0.141, 1}.

### Drill-Down Approach

As discussed previously, many resources, especially human resources, may be required to target or interact with individuals and organizations and persuade them to perform a particular action through one or more means, such as human contact, email, or online advertising. Thus, it is important that the individuals and organizations with the highest propensity to perform the particular action are targeted first.

In an embodiment, a user interface is generated that allows users to quickly view organizations and individuals who are associated with high OPSs and IPSs. The user(s) who view the user interface may be employees of the social network provider. For example, if the particular action that is being predicted is purchasing a particular product of the social network provider, then the users that will benefit from the user interface may be sales professionals of the social network provider. The user interface should be intuitive enough to allow non-technical personnel to obtain the information necessary to make decisions that are aligned with the social network provider's goals.

### Organizations View

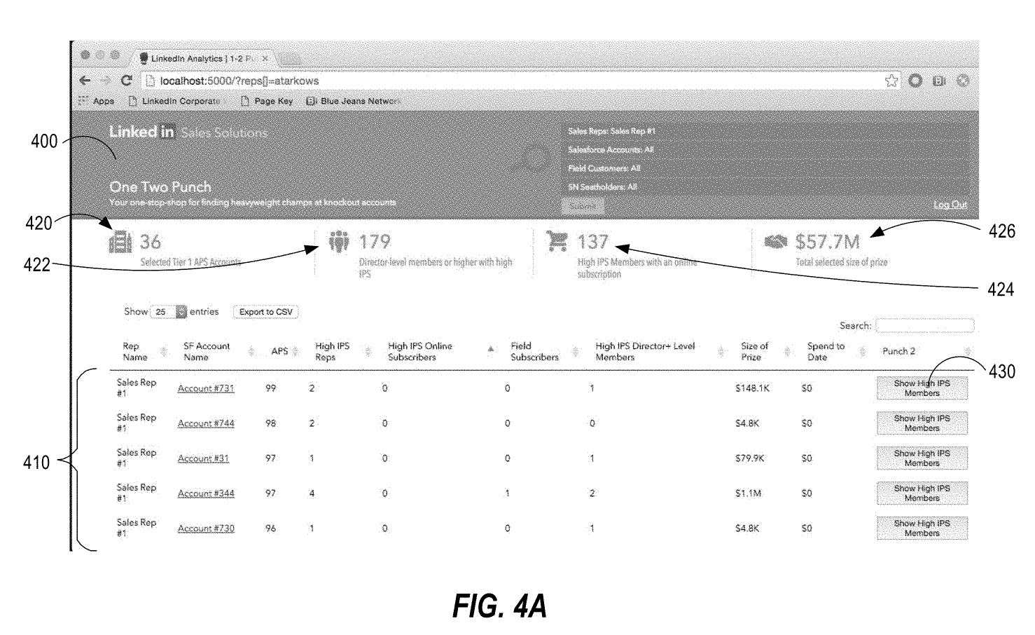

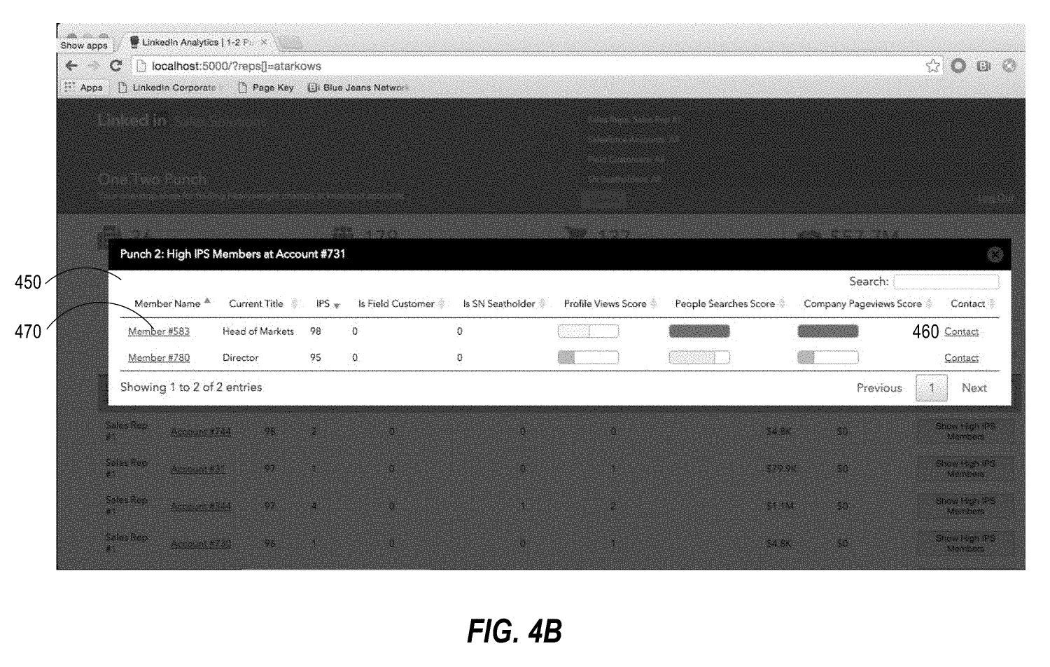

FIG. 4A is diagram that depicts an example screenshot of a user interface 400 that lists organizations based on OPS, in an embodiment. In this example, user interface 400 is generated for a particular sales representative (named “Sales Rep #1”) and lists a set of organizations (or “accounts”) 410 that have been assigned to the particular sales representative. Thus, other sales representatives will have similar, but different, user interfaces that provide the same type information. In the depicted example, set of accounts 410 is ranked or ordered based OPS, where the accounts associated with higher OPSs are listed above accounts associated with lower OPSs.

Server system 130 (or an affiliated system) generates user interface 400. User interface 400 is presented through a web browser (executing on the user's computing device) interacting with a web application executing on server system 130. Alternatively, user interface 400 is presented through a client application executing on the user's device.

User interface 400 presents multiple values of multiple attributes of each organization identified in set of accounts 410, including an OPS (or “APS”) of the organization, a number of “high” IPS representatives (or employees) of the organization, a number of “online subscribers” at the organization who have high IPSs, a number of “field subscribers,” a number of director-level members who have high IPSs, a size of prize (SOP), and an amount spent by the organization (or multiple representatives of the organization). An online subscriber is one who directly subscribes for a product or service (e.g., pays with his/her own money), while a field subscriber is one whose employer purchases a subscription and the employer gives the field subscriber a “seat” on that subscription, such that the field subscriber can use the product/service. Thus, for a given employer, there may be many seats for many employees of the employer.

An SOP of an organization refers to an estimation of maximum spending the organization will put towards services or products provided by another company, such as the social network provider. For example, the more employees at an organization who have a position or job function (e.g., sales professional) that will benefit from a product or service provided by the social network provider, the higher the SOP of that organization. For example, a yearly subscription to a product is $2,000 and there are five people at an organization with job titles that are associated with job functions that might or would use the product. Thus, the SOP of the organization is $2,000*5=$10,000 or $10K. In order to calculate an SOP for an organization, a set of members that are affiliated with the organization is determined and, for each member in the set, if the member is associated with a particular job title or job function, then the member is added to a particular set or a counter is incremented. Then, based on the number of members in the particular set or the value of the counter, an SOP is calculated.

The “amount spent” metric is tracked and maintained by server system 130. In user interface 400, the amount spent by an organization is a total amount spent by the organization to date. Additionally or alternatively, user interface 400 may indicate an amount spent over a different period of time, such as in a particular year or over the last two years, which may be a better indicator of the organization's present propensity to perform the particular action.

In addition to set of accounts 410 and the associated attribute values, user interface 400 includes other metrics, such as tier 1 accounts 420, high IPS director level members 422, high IPS subscribers 424, and total size-of-prize 426.

Tier 1 accounts 420 indicates a number of organizations that are associated with a relatively high OPS (or “APS” for account propensity score), such as greater than 0.83 on a 0-to-1 scale). Such organizations are referred to as “Tier 1” accounts. In this example, the user for which user interface 400 is generated has been assigned 36 Tier 1 accounts.

High IPS director-level members 422 indicates a number of individuals who have director-level job titles/positions or higher in their respective organizations and who also are associated with a relatively high IPS (e.g., greater than 0.78 on a 0-to-1 scale). The individuals are part of (e.g., employed by) organizations that are assigned to the viewer for which user interface 400 is generated.

High IPS subscribers 424 indicates a number of individuals who have an online subscription with the social network provider and who are associated with a relatively high IPS (e.g., greater than 0.69 on a 0-to-1 scale). The individuals are part of (e.g., employed by) organizations that are assigned to the user for which user interface 400 is generated.

Total SOP 426 indicates an estimation of maximum spending the organizations in the set of accounts 410 might put towards services or products provided by another company, such as the social network provider. An SOP is calculated for each organization that is assigned to the user (viewing user interface 400) and the resulting SOPs are summed or totaled to generate total SOP 426.

User interface 400 also includes a “Show High IPS Members” button (e.g., button 430) in association with each organization listed in set of accounts 410. Button 430 may be implemented using any type of graphical element, such as a link. When button 430 is selected (in particular, the first “Show High IPS Members” button), user interface 450 (depicted in FIG. 4B) is displayed.

### Individuals View

User interface 450 lists information about multiple individuals who are associated with the corresponding organization and who have relatively high IPSs (e.g., over 0.85 on a 0-to-1 scale). The individuals listed in user interface 450 may be ordered based on IPS, such that individuals with higher IPSs are listed before (or higher up in the list than) individuals with lower IPSs. In this example, user interface 400 is darkened and appears in the background. Alternatively, when user interface 450 is displayed, no part of user interface 400 is displayed.

User interface 450 includes information about two individuals (“Member #583” and “Member #780”) that are associated with (e.g., employed by) the selected organization. Information about each of the two individuals includes a name, a current job title, an IPS, whether the individual is already a customer (e.g., an online subscriber), whether the individual is already a field subscriber, and scores on three different IPS factors: profile view score, people search score, and company page view score. Individuals who are already subscribers (whether online subscribers or field subscribers) may have higher IPSs than individuals who are not subscribers, all else being equal. One use case is to approach online subscribers within a target organization and encourage them to “spread the word” internally, since online subscribers are incented to persuade their employer to sign a contract in order to avoid having to personally pay for the subscription. Another use case would be to approach field subscribers and try to expand that subscription by the organization purchasing more “seats.”

User interface 450 also includes, for each individual, a link (e.g., link 460) that, when selected, allows the selecting user to compose a message that can be sent to the corresponding individual. The message may be a text message that is sent over a cellular network to a telephone of the individual, an email message that is sent over the Internet to an email account of the individual, or a message that is sent to an online messaging account (of the individual) that is maintained by server system 130.

User interface 450 also includes, for each individual, a link (e.g., link 470) that, when selected, presents a profile (or portion thereof) of the corresponding individual. At least a portion of the profile was provided by the individual to the social network provider and stored in account database 132. Some of the data in the presented profile may be derived based on activities (e.g., searches for jobs, searches for people, number of endorsements given to others) that the individual initiated previously relative to server system 130.

Both link 460 and link 470 may be implemented using any other type of graphical element, such as a button.

### Factor Display

While three different scores are presented for each individual indicated in user interface 450, user interface 450 may include more or less scores. For example, there may be a score for each factor used in generating an IPS. Thus, if there are seven factors that are used to generate IPSs, then user interface 450 may present a separate score for each of the seven factors, regardless of whether the individual is deficient with respect to any of those factors. This allows a user who is viewing user interface 450 to tailor his approach with the individual based on the score information. Alternatively, user interface 450 may present a score for only those factors in which server system 130 determines that the corresponding individual is deficient (according to some standard or threshold (e.g., less than 0.5 on a 0-to-1 scale)) and needs to improve.

A score may be presented in numerous ways, such as a colored horizontal bar (as in user interface 450), a numerical number, a word, a letter, a shape, a graphic, or any combination thereof. A score may simply be a listing of the factor. Thus, if a factor is displayed in association with an individual, then that means the individual is considered deficient in that area. If a factor is not displayed in association with an individual, then that means the individual is not considered deficient in that area.

A profile view score is a score that server system 130 generates for the corresponding individual, indicating a number of times or how often (a frequency) the individual views other users' profiles. The more an individual requests to view other people's profiles, the higher the profile view score. A profile view score of an individual may reflect how much or how often the corresponding individual views other users' profiles relative to how much or how often other users view other users' profiles. For example, if one individual views more user profiles than all other users, then that individual may have a perfect (or the highest) profile view score, regardless of the absolute number of profile views. Alternatively, a profile view score reflects an absolute number of profile views. For example, two hundred profile views in a month is a perfect score and any number of profile views less than twenty is a 0.

A people search score is a score that server system 130 generates for an individual, indicating a number of times or how often the individual submits a search for people satisfying one or more criteria (or “people search”). The more an individual submits a people search, the higher the people search score. Similar to a profile view score, a people search score of an individual may reflect how much or how often the corresponding individual submits a people search relative to how much or how often other users submit people searches. Alternatively, a people search score reflects an absolute number of people searches submitted.

A company page view score is a score that server system 130 generates for an individual, indicating a number of times or how often the individual views company pages or submits requests (to server system 130) for “home” pages of companies that are registered with server system 130. The more an individual requests to view company pages, the higher the company page view score. Similar to a profile view score, a company page view score of an individual may reflect how much or how often the corresponding individual submits a people search relative to how much or how often other users submit people searches. Alternatively, a company page view score reflects an absolute number of company page views.

The three scores that are displayed on user interface 450 allow the viewer to quickly determine why an individual has an IPS that s/he has. Each score is a separate factor in generating an IPS. Without such score information, a viewer will not know why an individual has, for example, a low IPS or how the individual may improve his/her IPS. With the score information, the viewer can know how to target or interact with the corresponding individuals. In the depicted example, the two individuals have a relatively different score for each score that is listed (other than IPS). The second individual has relatively low profile view and company page view scores while the first individual has relatively high people search and company page view scores. Thus, the second individual may be interacted with differently than the first individual. For example, the second individual may be encouraged (either directly with a person or electronically through an online ad campaign) to increase the number of company page views while the first individual may be encouraged to increase the number of profile views. If the individuals are persuaded by such efforts, then the individuals will have higher IPSs and, importantly, will be more likely to perform the particular action.

User interface 450 also includes a search field for searching among the members listed in user interface 450 for a particular member satisfying certain criteria, such as a member with a specific job title or graduate degree. The search field allows a user to find one or more members without having to scroll through user interface 450 if user interface 450 lists many members.

Thus, user interfaces 400 and 450 are used together to allow a user to quickly determine which organizations to target and then which individuals within an organization to target. Such organizations and individuals are more likely to perform a particular action than other organizations and individuals.

### Example Two-Step Process

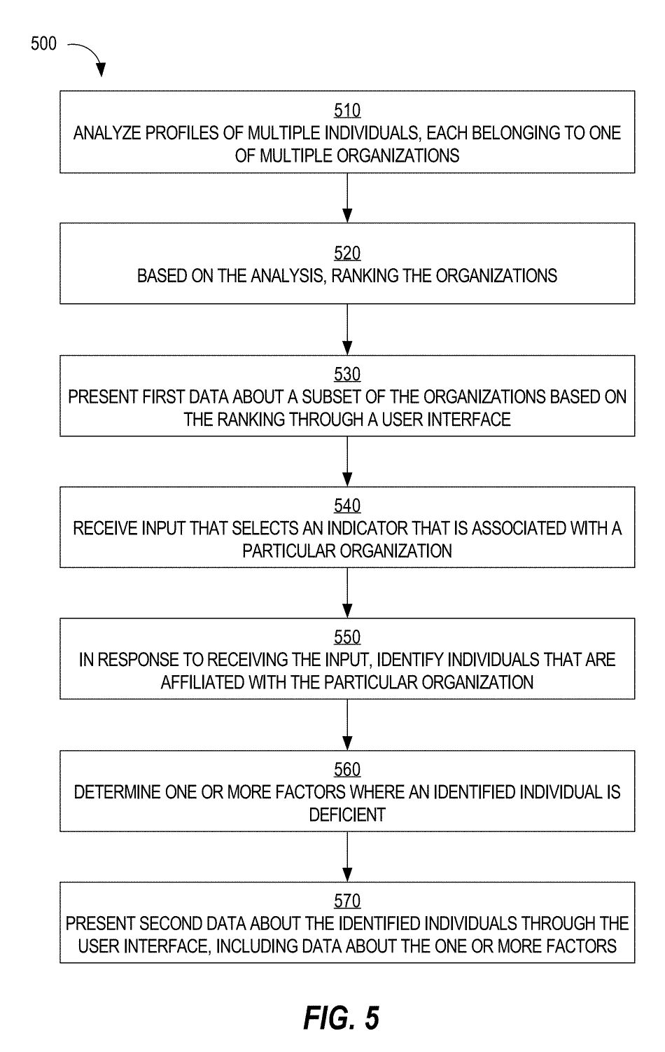

FIG. 5 is a flow diagram that depicts a process 500 for presenting information about organizations and individuals in a two-step process from the perspective of an end user, in an embodiment. Process 500 may be implemented by server system 130.

At block 510, profiles of multiple individuals are analyzed. Each of the individuals have registered with a social network provider and represents an organization of multiple organizations. Thus, some of the individuals may represent or work for the same organization. Block 510 may involve generating an IPS for each individual and an OPS for each of the organizations.

Block 510 may be limited to analyzing profiles of individuals that belong to or are associated with a set of organizations that is assigned to a particular user, such as a sales representative of the social network provider. Alternatively, block 510 is not so limited. Instead, block 510 involves analyzing profiles of individuals that are associated with organizations regardless of to which user the organization is assigned.

Additionally or alternatively, block 510 involves first identifying profiles of individuals who have a job title or job function that is in a particular set of job titles or job functions. The job title/job function may be specified in an individual's profiles or may be derived based on data specified in the individual's profile. Only profiles that satisfy the title/function criterion are analyzed.

At block 520, based on the analysis, the organizations are ranked. For example, if an OPS is generated for each organization, then the OPSs are used to rank or order the organizations from highest OPS to lowest OPS. Block 520 may involve only ranking organizations for the particular user. Alternatively, block 520 may involve ranking organizations, some of which are assigned to one user and some of which are assigned to another user.

At block 530, first data about a subset of the organizations is presented, based on the ranking, to a user through a user interface. This is the first step in the two-step process from the user's perspective. For example, server system 130 sends, over network 120, user interface data that is rendered in a web browser executing on a client device. The user interface data includes organization indicators (e.g., names) that are ordered based on the ranking. An example of the user interface data is presented in user interface 400.

At block 540, input that selects an indicator that is associated with a particular organization of the plurality of organizations is received through the user interface. The indicator is a graphical element, such as a link or button, an example of which is button 430.

At block 550, in response to receiving the input, a subset of the individuals is identified. Each individual in the subset is affiliated with (e.g., an employee or representative) of the particular organization.

At block 560, one or more scores that were generated for a particular individual in the subset are determined. Examples of factors of such scores include individual propensity factors described previously, such as a number of (user) profile views, a number of people searches, and a number of company page views.

At block 570, second data about the individuals in the subset are presented to the user through the user interface, including data that identifies the one or more scores and is associated with the particular individual. This is the second step in the two-step process from the perspective of the user. An example of the second data is presented in user interface 450. The second data may indicate a measure of activity of one of the factors relative to a measure of activity relative to other users who have registered with the social network provider.

In an embodiment, data that identifies the one or more factors is only presented if each of the one or more factors is less than a threshold score, such as a 50^{th} percentile relative to all individuals for whom an IPS has been generated.

Process 500 or portions thereof (e.g., 530-570) may be repeated for each end-user that is assigned a set of organizations. Thus, each end-user will be presented with information about a different set of organizations and individuals. For example, each end-user is a sales representative of the social network provider or another organization that is interesting in educating individuals of other organizations to use a particular product or service.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

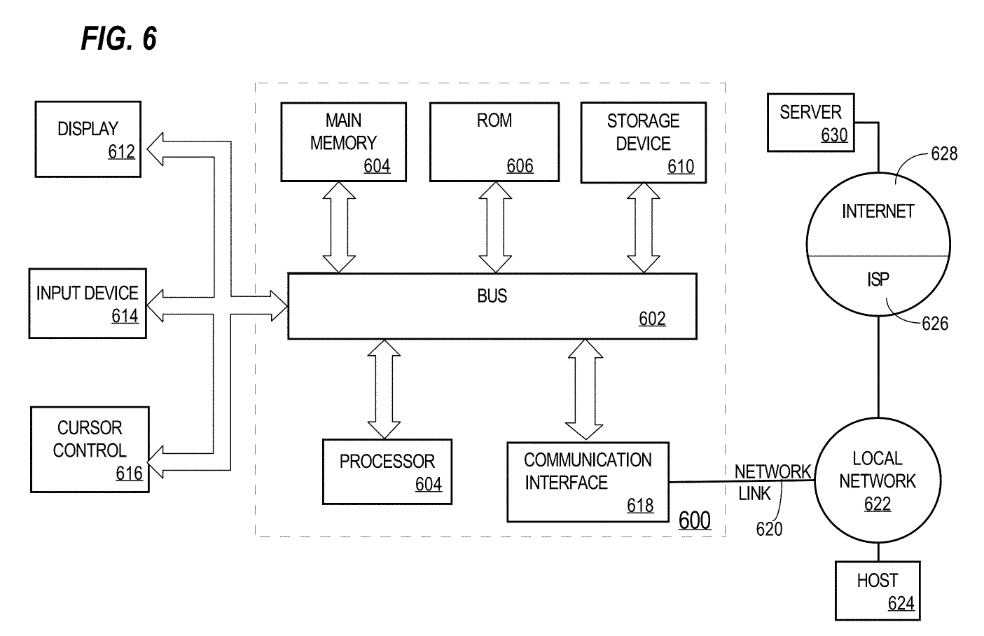

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A system comprising:
one or more processors;
one or more storage media storing instructions which, when executed by the one or more processors, cause:
performing an analysis of profiles of a plurality of representatives, each of which having registered with a social network provider and represent an organization from a plurality of organizations;
based on the analysis, generating a ranking of the plurality of organizations;
causing first data about a subset of the plurality of organizations to be presented, based on the ranking, through a user interface;
receiving, through the user interface, input that selects an indicator that is associated with a particular organization of the plurality of organizations;
in response to receiving the input, identifying a subset of the plurality of representatives, wherein each representative in the subset of the plurality of representatives is a representative of the particular organization;
determining one or more scores that were generated for a particular representative in the subset of the plurality of representative;
causing second data about the subset of the plurality of representatives to be presented through the user interface, wherein the second data identifies the one or more scores and associates the one or more scores with the particular representative.

2. The system of claim 1, wherein:
performing the analysis comprises generating a score for each representative of the plurality of representatives;
the score indicates a propensity for the corresponding representative to perform a particular action;
causing the second data to be presented comprises causing the second data to be presented based on the score.

3. The system of claim 1, further comprising:
based on the analysis, generating a plurality of scores, one for each organization of the plurality of organizations;
wherein each score of the plurality of scores indicates a propensity for the corresponding organization to perform a particular action;
wherein generating the ranking comprises generating the ranking based on the plurality of scores.

4. The system of claim 3, further comprising:
for each score of the plurality of scores, comparing said score to a threshold score;
wherein causing the first data about the subset of the plurality of organizations to be presented comprises causing, to be presented through the user interface, a number of organizations that are associated with scores that are greater than the threshold score.

5. The system of claim 1, wherein the one or more scores correspond to one or more factors that include one or more of: a number of searches of people, a number of page views of people, or a number of page views of organizations.

6. The system of claim 1, wherein the second data indicates a measure of activity of a factor corresponding to one of the one or more scores relative to activities of other users who have registered with the social network provider.

7. The system of claim 1, wherein the instructions, when executed by the one or more processors, further cause:
identifying the plurality of representatives from a set of members that have registered with the social network provider;
wherein identifying the plurality of representatives comprises, for each member in the set of members, determining, based on profile data provided by said each member to the social network provider, whether said each member is associated with a particular job title or job function.

8. The system of claim 1, wherein the plurality of organizations is a first plurality of organizations that are different than a second plurality of organizations, wherein the instructions, when executed by the one or more processors, further cause:
determining that a first user has been assigned to the first plurality of organizations and that a second user has been assigned to the second plurality of organizations;
wherein the user interface is a first user interface that is presented to the first user and that is different than a second user interface that is presented to the second user;
causing third data about a subset of the second plurality of organizations to be presented, based on a second ranking of the second plurality of organizations, through the second user interface;
receiving, through the second user interface, second input that selects a second indicator that is associated with a second organization of the second plurality of organizations;
in response to receiving the second input, identifying a subset of a second plurality of representatives, wherein each representative in the subset of the second plurality of representatives is a representative of the second organization;
determining one or more second scores that were generated for a second representative in the subset of the second plurality of representatives;
causing fourth data about the subset of the second plurality of representatives to be presented through the second user interface, wherein the fourth data includes data that identifies the one or more second scores and associates the one or more second scores with the second representative.

9. The system of claim 1, wherein the instructions, when executed by the one or more processors, further cause:
determining a set of members that are affiliated with the particular organization of the plurality of organizations;
for each member in the set of members:
determining, based on profile data provided by said each member to the social network provider, whether said each member is associated with a particular job title or job function at the particular organization;
adding said member to a particular set if it is determined that said member is associated with the particular job title or job function at the particular organization;
based on a number of members in the particular set, calculating a size of prize of the organization;
wherein causing the first data about the subset of the plurality of organizations to be presented through the user interface comprises causing the size of prize to be displayed on the user interface in association with the particular organization.

10. The system of claim 1, wherein:
causing the second data to be presented through the user interface comprises causing a graphical element to be presented adjacent to identification data that identifies the particular representative;
the instructions, when executed by the one or more processors, further cause:
receiving second input that selects the graphical element;
in response to receiving the input, causing a profile of the particular representative to be presented;
the profile includes profile data that was provided by the particular representative to the social network provider.

11. A method comprising:
performing an analysis of profiles of a plurality of representatives, each of which having registered with a social network provider and represent an organization from a plurality of organizations;
based on the analysis, generating a ranking of the plurality of organizations;
causing first data about a subset of the plurality of organizations to be presented, based on the ranking, through a user interface;
receiving, through the user interface, input that selects an indicator that is associated with a particular organization of the plurality of organizations;
in response to receiving the input, identifying a subset of the plurality of representatives, wherein each representative in the subset of the plurality of representatives is a representative of the particular organization;
determining one or more scores that were generated for a particular representative in the subset of the plurality of representative;
causing second data about the subset of the plurality of representatives to be presented through the user interface, wherein the second data identifies the one or more scores and associates the one or more scores with the particular representative;
wherein the method is performed by one or more computing devices.

12. The method of claim 11, wherein:
performing the analysis comprises generating a score for each representative of the plurality of representatives;
the score indicates a propensity for the corresponding representative to perform a particular action;
causing the second data to be presented comprises causing the second data to be presented based on the score.

13. The method of claim 11, further comprising:
based on the analysis, generating a plurality of scores, one for each organization of the plurality of organizations;
wherein each score of the plurality of scores indicates a propensity for the corresponding organization to perform a particular action;
wherein generating the ranking comprises generating the ranking based on the plurality of scores.

14. The method of claim 13, further comprising:
for each score of the plurality of scores, comparing said score to a threshold score;
wherein causing the first data about the subset of the plurality of organizations to be presented comprises causing, to be presented through the user interface, a number of organizations that are associated with scores that are greater than the threshold score.

15. The method of claim 11, wherein the one or more scores correspond to one or more factors that include one or more of: a number of searches of people, a number of page views of people, or a number of page views of organizations.

16. The method of claim 11, wherein the second data indicates a measure of activity of a factor corresponding to one of the one or more scores relative to activities of other users who have registered with the social network provider.

17. The method of claim 11, further comprising:
identifying the plurality of representatives from a set of members that have registered with the social network provider;
wherein identifying the plurality of representatives comprises, for each member in the set of members, determining, based on profile data provided by said each member to the social network provider, whether said each member is associated with a particular job title or job function.

18. The method of claim 11, wherein the plurality of organizations is a first plurality of organizations that are different than a second plurality of organizations, the method further comprising:
determining that a first user has been assigned to the first plurality of organizations and that a second user has been assigned to the second plurality of organizations;
wherein the user interface is a first user interface that is presented to the first user and that is different than a second user interface that is presented to the second user;
causing third data about a subset of the second plurality of organizations to be presented, based on a second ranking of the second plurality of organizations, through the second user interface;
receiving, through the second user interface, second input that selects a second indicator that is associated with a second organization of the second plurality of organizations;
in response to receiving the second input, identifying a subset of a second plurality of representatives, wherein each representative in the subset of the second plurality of representatives is a representative of the second organization;
determining one or more second scores that were generated for a second representative in the subset of the second plurality of representatives;
causing fourth data about the subset of the second plurality of representatives to be presented through the second user interface, wherein the fourth data includes data that identifies the one or more second scores and associates the one or more second scores with the second representative.

19. The method of claim 11, wherein the instructions, when executed by the one or more processors, further cause:
determining a set of members that are affiliated with the particular organization of the plurality of organizations;
for each member in the set of members:
determining, based on profile data provided by said each member to the social network provider, whether said each member is associated with a particular job title or job function at the particular organization;
adding said member to a particular set if it is determined that said member is associated with the particular job title or job function at the particular organization;
based on a number of members in the particular set, calculating a size of prize of the organization;
wherein causing the first data about the subset of the plurality of organizations to be presented through the user interface comprises causing the size of prize to be displayed on the user interface in association with the particular organization.

20. The method of claim 11, wherein:
causing the second data to be presented through the user interface comprises causing a graphical element to be presented adjacent to identification data that identifies the particular representative;
the method further comprising:
receiving second input that selects the graphical element;
in response to receiving the input, causing a profile of the particular representative to be presented;
the profile includes profile data that was provided by the particular representative to the social network provider.
